(19) United States
(12) Patent Application Publication
(10) Pub. No.: US 2009/0133620 A1
(43) Pub. Date: May 28, 2009

(54) Sealer Coater

(75) Inventors: Miyuki Osaki, Tokyo (JP); Shinji Yamamoto, Tokyo (JP); Fumio Nishimura, Tokyo (JP); Shuji Ueda, Tokyo (JP); Tatsuya Aritake, Tokyo (JP); Jun-ichi Suzuki, Kanagawa (JP)

Correspondence Address: BIRCH STEWART KOLASCH & BIRCH, PO BOX 747, FALLS CHURCH, VA, 22040-0747, US

(73) Assignee: HONDA MOTOR CO., LTD, TOKYO (JP)

(21) Appl. No.: 12/223,393

(22) PCT Filed: Feb. 1, 2007
(86) PCT No.: PCT/JP2007/052163

§ 371 Date: Sep. 5, 2008

(30) Foreign Application Priority Data
Feb. 3, 2006 (JP) 2006-027143

(51) Int. Cl. B05B 13/04

(52) U.S. Cl. 118/323; 901/43

(57) ABSTRACT

A sealer coater (20) comprising cylinder unit (22) arranged to be joined with a robot arm (16), a floating base (24) joined with the piston rod of this cylinder unit, a compression spring (25) provided between the floating base and the cylinder unit to urge the piston rod in the forward direction, and a plurality of nozzles (21) attached to the floating base to eject sealer. The nozzles for applying sealer are supported on one cylinder unit, thereby eliminating the need of a plurality of cylinder units and enabling downsizing of the sealer coater.

### TECHNICAL FIELD

The present invention relates to a sealer coater for applying a sealer onto a surface of an object to be sealer-coated.

### BACKGROUND ART

For connecting a first steel plate and a second steel sheet, an edge of the second steel sheet is laid on an edge of the first steel sheet, followed by spot-welding the edges. By such spot welding, edge portions between spot welds are not welded, leaving gaps at such non-welded parts. These gaps allow water to enter to thereby cause rust on surfaces of the plates. For rusting- or water-proof of the plates, a liquid of high viscosity, called sealer, is filled in the gaps.

Conventionally, sealer has been applied by hands. In recent years, robots and sealer coating apparatuses are employed for automatic application. One example of such sealer coating apparatuses is disclosed in Japanese Patent Application Laid-Open Publication No. 2003-117461, which will be described below with reference to FIG. 6 hereof.

As shown in the FIG. 6, a sealer coater 100 comprises four cylinder cases 102 (two at the center overlap) attached to a distal end of a robot arm 101 and extending rightwardly in the Figure, a piston rod 103 extending from each cylinder case 102, a compression spring 104 for urging the respective piston rod 103 to protrude from the respective air cylinder case rightwardly in the Figure, a bridge member 105 for connecting the distal ends of the piston rods 103, and a nozzle 106 attached to the bridge member 105.

Sealer coating process includes two operations, namely, a sealer coating operation in which coating of a sealer discharged from the nozzle 106 is carried out and a nozzle moving operation in which the nozzle 106, with the sealer discharge interrupted, is moved from a standby position to the vicinity of a sealer application position.

In the nozzle moving operation, air is fed into the cylinder cases 102 to cause the piston rods 103 to fully project so that the piston rods 103 are held stationary relative to the cylinder cases 102. In this state, even when the robot arm 101 is moved three dimensionally, the nozzle 106 stays wobbling-free.

Immediately before the sealer coating operation, air is discharged from the cylinder cases 102 to allow the piston rods 103 to move back and forth freely. At this time, the piston rods 103 are brought to fully advanced or protruded positions by the resiliency of the compression springs 104. In this state, the nozzle 106 is brought into confronting relation to the object to be applied with the sealer. When an external force acts on the nozzle 106 by its contact with the object, the compression springs 104 are compressed to allow the nozzle 106 to retract or move backwardly. Further, part of the plural compression springs 104 arranged in juxtaposition may be compressed to tilt the nozzle 106. Such backward and tilt movements of the nozzle 106 prevent the nozzle 106 from being injured by contact of the nozzle with the to-be-coated object.

However, since the above-described sealer coater 100 requires four cylinder cases 102 as main components, it inevitably becomes large, thus leaving a demand for a down-sized sealer coater.

Further, since the four compression springs 104 are provided on the sealer coater 100, a difference in spring constant will inevitably arise among the springs. With such a difference in spring constant, the nozzle 106 will be tilted relative to the robot arm 101. As a result, control of the robot arm 101 becomes difficult. Such difficulty may be eased by a robot teaching operation but the same operation becomes complex and tedious.

Consequently, there is a demand for a small-sized sealer coater that requires a simple robot teaching operation.

### DISCLOSURE OF THE INVENTION

According to the present invention, there is provided a sealer coater adapted to be mounted to a distal end of a robot arm, which comprises: a cylinder unit adapted to be joined with the robot arm and having a cylinder unit with a cylinder case; a piston movably received in the cylinder case; a piston rod extending from the piston outwardly of the cylinder case; a floating base swingably joined to a distal end of the piston rod; a compression spring provided between the floating base and the cylinder unit in such a manner as to surround an outer periphery of the cylinder case, for urging the piston rod in an advancing direction; and a plurality of nozzles attached to the floating base for discharging a sealer.

The sealer-applying nozzles are thus supported on a single cylinder unit. As a result, there is no need to provide plural cylinder units, thus enabling downsizing of the sealer coater.

With the single compression spring provided on the single cylinder unit, there is no fear of encountering discrepancies in spring constants. This leads to the advantage that tilting of the nozzles is prevented. As a result, the robot teaching operation is made simple.

Preferably, the cylinder unit is joined to the robot arm such that an axis of the piston rod lies on or coincide with a center line of the robot arm.

With the axis of the piston rod arranged to coincide with the center line of the robot arm, a force acting on the piston rod can be transmitted directly to and born by the robot arm. As a result, the load applied to the robot arm can be reduced.

Preferably, the cylinder case has, on a surface thereof facing the floating base, one of a plurality of recesses and a plurality of projections designed for fitted engagement with the recesses, while the floating base has, on a surface thereof facing the cylinder case, another one of the plurality of recesses and the plurality of projections.

With the projections and recesses engaged with each other, the floating base can be precisely positioned on the cylinder case. With the robot arm, cylinder case, floating base and nozzles are interconnected in the order in which they are mentioned, the nozzles can be precisely synchronized and harmonized with the robot arm. As a result, the nozzles can be positioned with high accuracy and the robot teaching operation becomes easy.

### BRIEF DESCRIPTION OF THE DRAWINGS

FIG. 1 is a schematic view illustrating a state of use of a sealer coater according to the present invention;

FIG. 2 is an enlarged side view of the sealer coater;

FIG. 3 is an enlarged view of part 3 of FIG. 2;

FIG. 4 is a cross-sectional view illustrating on an enlarged scale the part 3 of FIG. 2;

FIGS. 5A to 5C are schematic views showing an operation of the part shown in FIG. 4; and

FIG. 6 is a schematic view showing the arrangement of a conventional sealer coater.

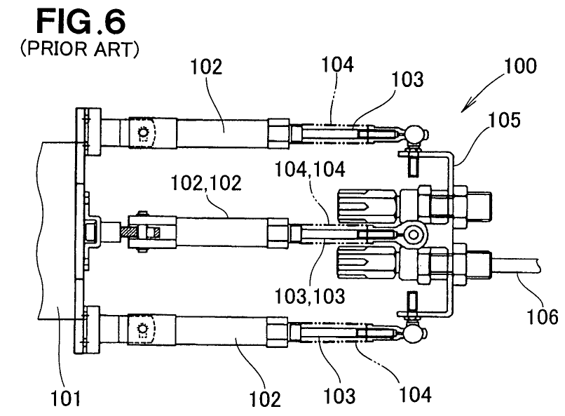

### BEST MODE FOR CARRYING OUT THE INVENTION

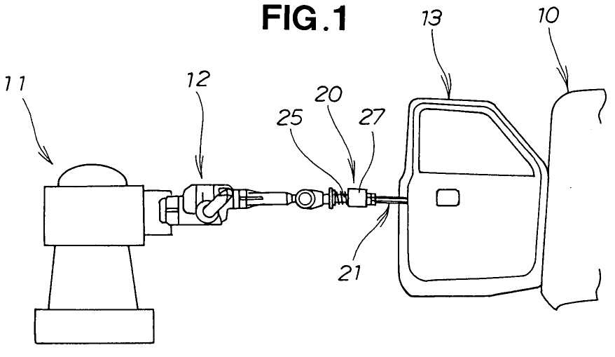

As shown in FIG. 1, a robot 11 is positioned closely to a vehicle body 10. The robot 11 has a robot arm 12 extending toward the vehicle body. A sealer coater 20 is mounted to a distal end of the robot arm 12. Nozzles 21 extending from the distal end of the robot arm are brought into an opposed relation to a sealer application part of the vehicle body 10, e.g., a hemmed peripheral edge part of a door 13 for sealer coating thereto.

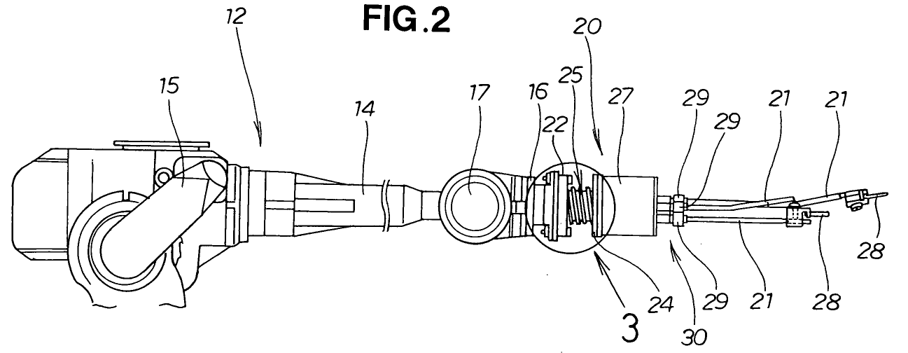

As shown in FIG. 2, the robot arm 12 includes a first shaft 15 for rotatably supporting a first arm 14, and a second shaft 17 for rotatably connecting a second arm 16 to the first arm 14 so as to allow movement of the second arm 16 to an arbitrary position.

The sealer coater 20 is mounted to the second arm 16.

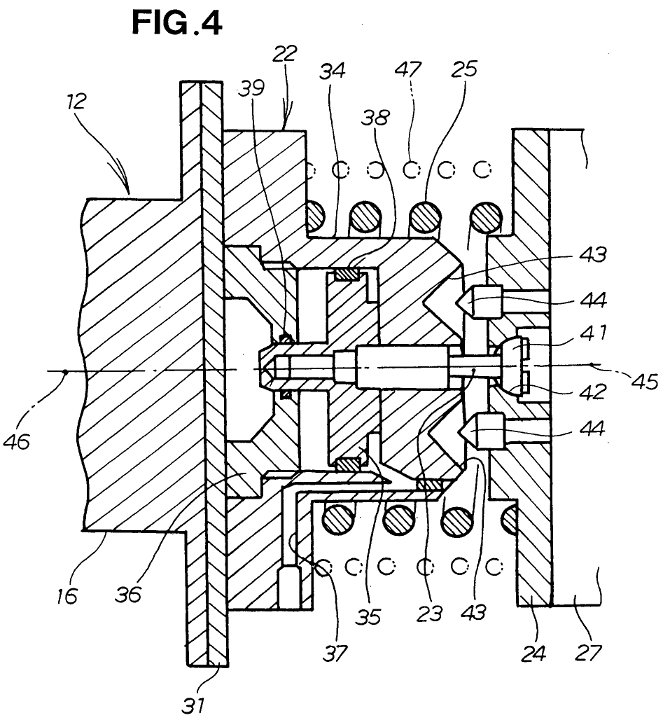

The sealer coater 20 is provided with a cylinder unit 22 connected to the second arm 16, a floating base 24 connected to a piston rod 23 (see FIG. 4; designated by reference numeral 23) of the cylinder unit 22, a compression spring 25 provided between the floating base 24 and the cylinder unit 22 for urging the piston rod 23 forwardly, and the nozzles 21 attached to the floating base 24 for discharging a sealer.

Each nozzle 21 extends from a single housing 27 and has a guide member 28 at a distal end thereof. The guide member 28 has a rod-shaped configuration and is brought into contact with the sealer-applied part for sliding movement therealong. It is desirable that the guide member 28 be made from a material having a small coefficient of friction, such as a polyacetal resin.

More specifically, the sealer coater 20 is a contact-type coating apparatus with the guide member 28 abutted against the hemmed part of the periphery of the object to be coated, such as a door, a trunk lid, an engine hood, a tale gate, etc., for guiding the nozzles 21 to apply a sealer thereto.

Reference numeral 29 designates an attachment tool for detachably fastening the nozzles 21 to the housing 27. The nozzles 21 can be removed from the housing 27 for replacement with others of different sizes or types.

Various types of nozzle units 30, each comprised of the housing 27 and nozzles 21 attached thereto, may be provided so that one of the units may be selected and fastened to the floating base 24 so as to easily cater to vehicles of different models.

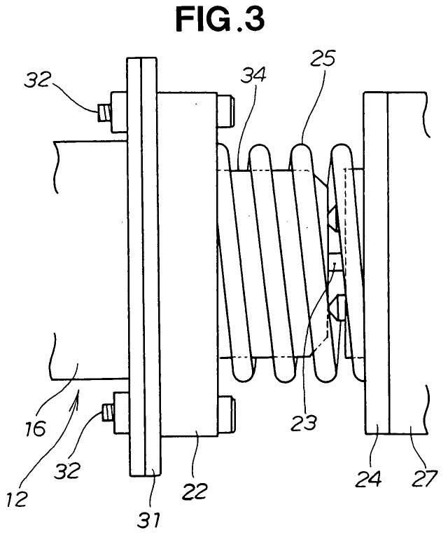

Turning now to FIG. 3, the cylinder unit 22 is mounted to a distal end of the robot arm 12 by bringing the base plate 31 into abutment with the second arm 16, bringing the back surface of the cylinder unit 22 into abutment with the base plate 31, and then fastening them with bolts 32, 32.

As shown in FIG. 4, the cylinder unit 22 includes a cylinder case 34, a piston 35 movably received in the cylinder case 34, and the piston rod 23 extending from the piston 35 outwardly of the cylinder case 34. The cylinder case 34 is sealed with a lid 36 after the piston 35 is housed therein, and has an air supply channel 37 through which air as a working fluid is supplied to the cylinder case 34 to cause the piston rod 23 to retract. Seal members 38, 39 such as O-rings are provided on the piston 35, there is no fear of supplied air from leaking outside.

The piston rod 23 has a spherical cap 41 at a distal end thereof. The floating base 24 has a spherical seat 42 provided thereon for receiving the spherical cap 41. The spherical cap 41 is seated within the spherical seat 42 such that the floating base 24 is swingably joined to the piston rod 23.

Further, a plurality of recesses 43 is provided a cylinder case surface facing the floating base 24, while a plurality of projections 44 is provided on floating base surface facing the cylinder case 34 for fitting in the respective recesses 43. It is desirable that the recesses 43 and the projections 44 be conical in shape so that they tightly engage with each other.

Alternatively, the projections 44 may be provided on the cylinder case surface facing the floating base 24, while the recesses 43 may be formed on the floating base surface facing the cylinder case 34. Although the four recesses 43 are basically provided in this embodiment, three, five or more recesses may be suitably provided. The same applies to the projections 44.

Furthermore, the cylinder case 34 is connected to the robot arm 12 such that an axis 45 of the piston rod 23 coincide with a center line 46 of the robot arm 12. With the piston rod axis arranged to coincide with the center line of the robot arm, it becomes possible to have a force acted on the piston rod 23 transmitted directly to and born by the robot arm 12. As a result, there is no fear of a biased or inclined external force acting on the piston rod 23, thus reducing the load on the robot arm 12.

The compression spring 25 urges the floating base 24 in a direction away from the cylinder case 34. Alternatively, a second compression spring 47 shown by an imaginary line in FIG. 4 may be provided around the compression spring 25. That is, plural compression springs may be provided to the sealer coater 20.

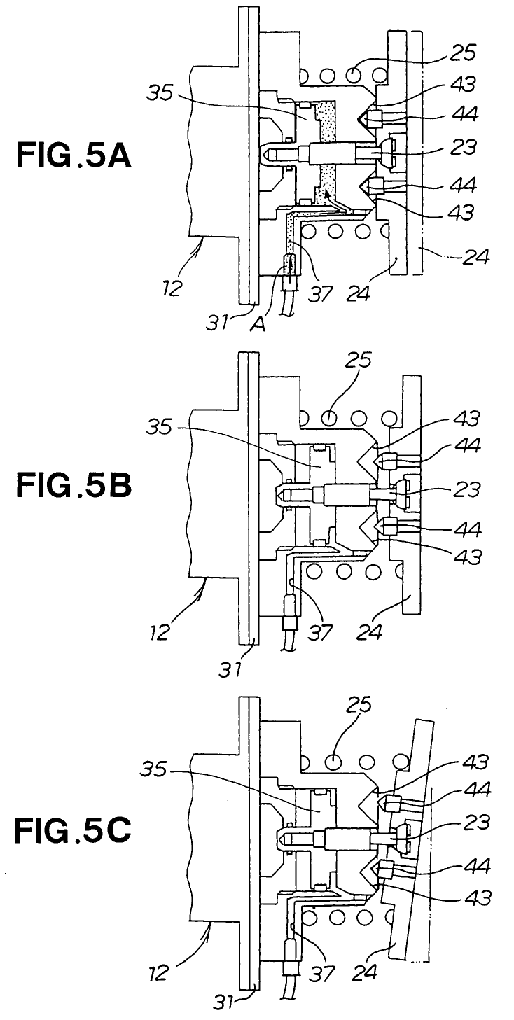

An operation of the arrangement shown in FIG. 4 will be described next with reference to FIGS. 5A to 5C.

In FIG. 5A, compressed air A is fed into the air supply channel 37 to cause the piston 35 to move leftward in the Figure. Along with the movement of the piston 35, the piston rod 23 and the floating base 24 move leftward in the Figure. More specifically, the floating base 24 moves from a position shown by a phantom line to a position shown by a solid line. At this time, the compression spring 25 is compressed. In addition, the projections 44 provided on the floating base 24 and the recesses 43 foamed on the cylinder case 34 are brought into mating engagement with each other. The floating base 24 is thus unitarily fixed to the cylinder case 34 so that the floating base 24 does not move independently from or relative to the robot arm 12.

To sum up, FIG. 5A illustrates an operation or process in which the nozzles are moved from a standby position to a vicinity of the object to be applied with a sealer. Because the robot arm 12 can be moved at a high speed and stopped instantly, the required nozzle movement operation may be finished quickly.

As the nozzle moving work is completed, the supply of the compressed air A is terminated and the compression air A is discharged from the air cylinder 34 through the air supply channel 37. At this time, as shown in FIG. 5B, the compressed compression spring 25 is released to thereby press the floating base 24, piston rod 23 and piston 35 rightward in the Figure. At the same time, the projections 44 are disengaged from the recesses 43. As a result, the floating base 24 becomes movable leftward in the FIG. 5B and tiltable as shown in FIG. 5C. Even when the nozzles 21 are brought into contact with the to-be-coated object, the floating base 24 is backwardly moved or tilted to thereby prevent the nozzles 21 from being damaged by the external force.

Thus, FIGS. 5B and 5C illustrate a sealer coating operation or work.

The cylinder unit may be joined to the robot arm such that an axis of the piston rod lies parallel to the center line of the robot arm.

Further, higher compressed air may be used to firmly press the floating base 24 against the cylinder case 34. In this instance, the recesses and projections may be omitted.

Furthermore, the sealer coater may be of a non-contact type which is different than the contact type one employed in the preferred embodiment described above. Although the sealer coater has been described in relation to its use in applying a sealer to a vehicle door, the sealer coater may also be used in applying a sealer to a hemmed part of a vehicle body, such as an engine hood, a trunk, a tale gate, etc. and in sealer coating processes other than those of the automobile production.

### INDUSTRIAL APPLICABILITY

As is clear from above description, the inventive sealer coater to be joined to a robot arm is particularly useful for applying a sealer on an automobile door.

1-3. (canceled)

4. A sealer coater designed to be mounted to a distal end of a robot arm, comprising
a cylinder unit adapted to be joined with the robot arm and having a cylinder unit with a cylinder case;
a piston movably received in the cylinder case;
a piston rod extending from the piston outwardly of the cylinder case and having an axis coinciding with a center line of the robot arm;
a lid for, after the piston is housed in the cylinder case, closing the cylinder case and slidably supporting the piston rod at a rear end of the latter;
a seal member disposed between the lid and the piston rod for preventing air leakage;
a floating base swingably joined to a distal end of the piston rod;
a compression spring provided between the floating base and the cylinder unit in such a manner as to surround an outer periphery of the cylinder case, for urging the piston rod in an advancing direction; and
a plurality of nozzles for discharging a sealer, the nozzles being attached to a housing which in turn is attached to the floating base such that they extend along the centerline of the robot arm.

5. The sealer coater of claim 4, wherein the cylinder case has, on a surface thereof facing the floating base, one of a plurality of recesses and a plurality of projections designed for fitted engagement with the recesses, and the floating base has, on a surface thereof facing the cylinder case, another one of the plurality of recesses and the plurality of projections.
